(19) United States
(12) Patent Application Publication
(10) Pub. No.: US 2019/0384105 A1
(43) Pub. Date: Dec. 19, 2019

(54) LIQUID CRYSTAL DISPLAY PANEL AND LIQUID CRYSTAL DISPLAY DEVICE

(71) Applicant: Wuhan China Star Optoelectronics Technology Co., Ltd, Wuhan, Hubei (CN)

(72) Inventor: Gege ZHOU, Wuhan, Hubei (CN)

(21) Appl. No.: 15/579,101

(22) PCT Filed: Nov. 14, 2017
(86) PCT No.: PCT/CN2017/110763

§ 371 Date: Dec. 1, 2017

(30) Foreign Application Priority Data
Oct. 30, 2017 (CN) 201711039726.6

(51) Int. Cl. G02F 1/1335; G02F 1/1368; C09J 9/02

(52) U.S. Cl. CPC G02F 1/133528; G02F 1/1368; G02F 2202/28; C09J 9/02; G02F 1/133514

(57) ABSTRACT

A liquid crystal display panel is provided. The liquid crystal display panel includes a lower polarizing plate, a TFT array substrate, a color filter substrate and an upper polarizing plate provided in order, wherein the upper polarizing plate has an electrical conductivity; a first surface of the color filter substrate toward the upper polarizing plate is provided with a recess; the recess is filled with a conductive adhesive; the upper polarizing plate is electrically connected to the color filter substrate by the conductive adhesive. A liquid crystal display device includes the above liquid crystal display panel is also provided.

### RELATED APPLICATIONS

The present application is a National Phase of International Application Number PCT/CN2017/110763, filed Nov. 14, 2017, and claims the priority of China Application No. 201711039726.6, filed Oct. 30, 2017.

### FIELD OF THE DISCLOSURE

The disclosure relates to a display technical field, and more particularly to a liquid crystal display panel and a liquid crystal display device.

### BACKGROUND

The LCD (Liquid Crystal Display) is a flat and ultra-thin display device. The LCD consists of several color or black-white pixels placed in front of the light source or the reflecting surface. With the low power consumption, high quality, small size and light weight, the LCD is favored by people and being the mainstream. As shown in FIG. 1, a conventional liquid crystal display panel comprises at least a TFT array substrate 1 and a color filter substrate 2 provided opposite to each other and a liquid layer (not shown) located between the TFT array substrate 1 and the color filter substrate 2. The TFT array substrate 1 and the color filter substrate 2 is further stacked with a lower polarizing plate 3 and an upper polarizing plate 4, respectively.

During the manufacturing and using process of the liquid crystal display panel, it is easy to produce the static electricity and gather the static electricity to the color filter substrate. An electrostatic field is created when the static electricity is accumulated to a certain degree, and such an electrostatic field would disturb the electric filed of the liquid crystal molecules in the liquid crystal display panel, thereby resulting in abnormal display. In the prior art, for eliminate the influence of the static electricity, a current solution is the following. As shown in FIG. 1, the upper polarizing plate 4 uses a polarizing plate having electrical conductivity. Dispensing a conductive adhesive 5 via the edge of the upper polarizing plate 4 located directed above the color filter substrate 2, and then connecting the conductive adhesive 5 to an external electrostatic protection circuit to eliminate the static electricity accumulated on the color filter substrate 2. However, the implement of dispensing the conductive adhesive 5 makes the conduction of the circuit unstable. Moreover, the conductive adhesive 5 is only in contact with the edge of the upper polarizing plate 4, such a small contact area causes poor conductivity and finally leads to poor static electricity discharge.

Therefore, the prior art needs to be improved and developed.

### SUMMARY

In view of the deficiencies of the prior art, the disclosure provides a liquid crystal display panel, which can eliminate the static electricity accumulated on the color filter substrate, thereby improving the displaying quality of the liquid crystal display panel.

For achieving the above-mentioned objects, the following embodiments are described in the disclosure.

A liquid crystal display panel comprises a lower polarizing plate, a TFT array substrate, a color filter substrate, and an upper polarizing plate, wherein the upper polarizing plate has an electrical conductivity; a first surface of the color filter substrate toward the upper polarizing plate is provided with a recess; the recess is filled with a conductive adhesive; the upper polarizing plate is electrically connected to the color filter substrate by the conductive adhesive.

In an embodiment, a side end surface of the upper polarizing plate is located directly above the recess, and wherein a portion of the conductive adhesive is covered by the upper polarizing plate, and another portion of the conductive adhesive is exposed from a side end surface of the upper polarizing plate.

In an embodiment, the conductive adhesive exhibits bilateral symmetry with respect to the side end surface of the upper polarizing plate.

In an embodiment, the recess has an opening with a square shape on the first surface of the color filter substrate.

In an embodiment, the upper surface of the conductive adhesive is flush with the first surface.

In an embodiment, the conductive adhesive is a conductive silver paste.

In an embodiment, the conductive adhesive is filled in the recess by a coating process or a printing process.

Furthermore, the disclosure provides a liquid crystal display device comprising a liquid crystal display panel and a backlight module opposite to the liquid crystal display panel, wherein the backlight module provides a display light source for the liquid crystal display panel such that the liquid crystal display panel displays an image, and wherein the liquid crystal display panel comprises a lower polarizing plate, a TFT array substrate, a color filter substrate and an upper polarizing plate provided in order, the upper polarizing plate having an electrical conductivity, a first surface of the color filter substrate toward the upper polarizing plate being provided with a recess, the recess being filled with a conductive adhesive, and the upper polarizing plate being electrically connected to the color filter substrate by the conductive adhesive.

In an embodiment, a first surface of the color filter substrate toward the upper polarizing plate is provided with a recess, which filled with a conductive adhesive, and the upper polarizing plate is electrically connected to the color filter substrate by the conductive adhesive, such that the electrical connection between the upper polarizing plate and the color filter substrate is more stable and the contact area between the conductive adhesive and the upper polarizing plate is larger. Auch such, the static electricity accumulated on the color filter substrate can be eliminated, thereby improving the displaying quality of the liquid crystal display panel.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a structural schematic view of a current liquid crystal display panel;

FIG. 2 is a structural schematic view of a liquid crystal display panel according to an embodiment of the disclosure;

FIG. 3 is a structural schematic view of a recess located above the color filter substrate according to an embodiment of the disclosure; and

FIG. 4 is a structural schematic view of a liquid crystal display device according to an embodiment of the disclosure.

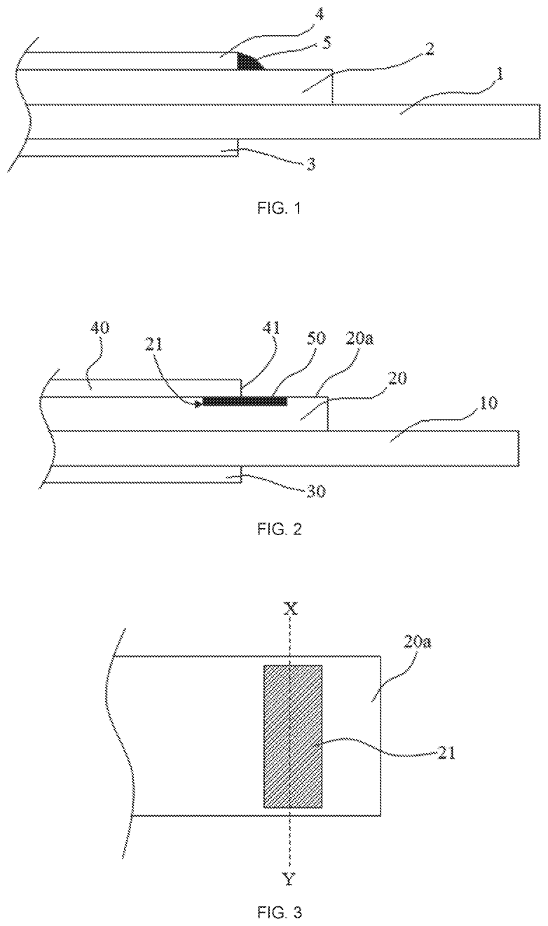

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

The disclosure will be further described in detail with reference to accompanying drawings and preferred embodiments as follows.

As shown in FIG. 2, which illustrates a liquid crystal display panel according to one embodiment of the disclosure, the liquid crystal display panel includes a lower polarizing plate 30, a TFT array substrate 10, a color filter substrate 20 and upper polarizing plate 40. The TFT array substrate 10 and the color filter substrate 20 are provided opposite to each other, and a liquid layer (not shown) is provided between the TFT array substrate 10 and the color filter substrate 20.

Referring to FIGS. 2 and 3, the upper polarizing plate 40 uses a polarizing plate having an electrical conductivity; the color filter substrate 20 has a first surface 20a toward the upper polarizing plate 40 and a recess 21 is provided on the first surface 20a; the recess 21 is filled with a conductive adhesive 50; and the upper polarizing plate 40 is electrically connected to the color filter substrate 20 by the conductive adhesive 50. The static electricity created by the color filter substrate 20 throughout gather to the conductive adhesive 50 by the upper polarizing plate 40 having the electrical conductivity, and then conduct to an external static electricity protection circuit via the conductive adhesive 50. As such, the static electricity can be discharged safely so as to prevent from the adverse effect on the liquid crystal display panel due to the accumulation of the static electricity.

The conductive adhesive 50, for example, can be a conductive silver paste, and the conductive adhesive 50 can be filled in the recess 21 by a coating process or a printing process.

Specially, referring to FIGS. 2 and 3, a side end surface 41 of the upper polarizing plate 40 is located directly above the recess 21 (the X-Y line in FIG. 3 can be regarded as the projection of the side end surface 41 on the recess 21), such that a portion of the conductive adhesive 50 is covered by the upper polarizing plate 40 and another portion of the conductive adhesive 50 is exposed from the upper polarizing plate 40 (or protruding from the side end surface 41 of the upper polarizing plate 40). The conductive adhesive 50 is provided in the recess 21 of the color filter substrate 20. Without the influence of the assembly of the upper polarizing plate 40, the volume of the conductive adhesive 50 can be increase (i.e., the self-resistance ban be reduced) and the contact area between the conductive adhesive 50 and the upper polarizing plate 40 can be larger, so as to more stabilize a circuit eliminating the static electricity and be beneficial to the static electricity conducting outward. Moreover, the conductive adhesive 50 is provided in the recess 21 to ensure the conductive adhesive 50 has a larger thickness to reduce the self-resistance. Therefore, the conductive adhesive 50 can be only provided in the neighboring region of the side end surface 41 of the upper polarizing plate 40 without coating entirely the first surface 20a of the color filter substrate 20, so as to prevent from affecting the display performance of the liquid crystal display panel, such as reducing the light transmissivity.

In some embodiments, as shown in FIG. 3, the recess 21 has an opening shaped square on the first surface 21a of the color filter substrate 20. With respect to a location of the recess 21 above which the side end surface 41 is located directly, such as the X-Y line in FIG. 3, the conductive adhesive 50 exhibits bilateral symmetry.

In another embodiment, the upper surface of the conductive adhesive 50 can be flush with first surface 20a of the color filter substrate 20, so as to ensure the well contact between the upper polarizing plate 40 and the conductive adhesive 50 and to prevent from adverse bubbles when attaching the upper polarizing plate 40 due to a dislocation between the first surface 20a and the conductive adhesive 50.

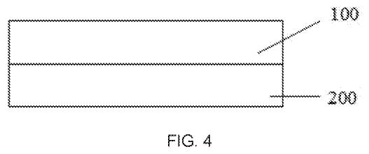

As shown in FIG. 4, which illustrates a liquid crystal display device according to another embodiment of the disclosure. The liquid crystal display device comprises a liquid crystal display panel 100 and a backlight module 200 opposite to the liquid crystal display panel 100, and the backlight module 200 provides a display light source for the liquid crystal display panel 100 such that the liquid crystal display panel 100 displays an image, wherein the liquid crystal display panel 100 uses the above liquid crystal display panel.

Moreover, terms such as “first” and “second” are merely for the purpose of illustration and cannot be understood as indicating or implying the relative importance or implicitly indicating the number of the technical feature. Therefore, features defined by “first” and “second” can explicitly or implicitly include one or more the features. In the description of the disclosure, unless otherwise indicated, the meaning of “plural” is two or more than two. In addition, the term “comprise” and any variations thereof are meant to cover a non-exclusive inclusion.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A liquid crystal display panel, comprising a lower polarizing plate, a TFT array substrate, a color filter substrate and an upper polarizing plate provided in order, wherein the upper polarizing plate has an electrical conductivity, wherein a first surface of the color filter substrate toward the upper polarizing plate is provided with a recess, wherein the recess is filled with a conductive adhesive, and wherein the upper polarizing plate is electrically connected to the color filter substrate by the conductive adhesive.

2. The liquid crystal display panel according to claim 1, wherein a side end surface of the upper polarizing plate is located directly above the recess, and wherein a portion of the conductive adhesive is covered by the upper polarizing plate, and another portion of the conductive adhesive is exposed from a side end surface of the upper polarizing plate.

3. The liquid crystal display panel according to claim 2, wherein the conductive adhesive exhibits bilateral symmetry with respect to the side end surface of the upper polarizing plate.

4. The liquid crystal display panel according to claim 2, wherein the recess has an opening shaped square on the first surface of the color filter substrate.

5. The liquid crystal display panel according to claim 2, wherein the upper surface of the conductive adhesive is flush with the first surface.

6. The liquid crystal display panel according to claim 2, wherein the conductive adhesive is a conductive silver paste.

7. The liquid crystal display panel according to claim 2, wherein the conductive adhesive is filled in the recess by a coating process or a printing process.

8. A liquid crystal display device, comprising a liquid crystal display panel and a backlight module provided opposite to the liquid crystal display panel, wherein the backlight module provides a display light source for the liquid crystal display panel such that the liquid crystal display panel displays an image, and wherein the liquid crystal display panel comprises a lower polarizing plate, a TFT array substrate, a color filter substrate and an upper polarizing plate provided in order, the upper polarizing plate having an electrical conductivity, a first surface of the color filter substrate toward the upper polarizing plate being provided with a recess, the recess being filled with a conductive adhesive, and the upper polarizing plate being electrically connected to the color filter substrate by the conductive adhesive.

9. The liquid crystal display device according to claim 8, wherein a side end surface of the upper polarizing plate is located directly above the recess, and wherein a portion of the conductive adhesive is covered by the upper polarizing plate, and another portion of the conductive adhesive is exposed from a side end surface of the upper polarizing plate.

10. The liquid crystal display device according to claim 9, wherein the conductive adhesive exhibits bilateral symmetry with respect to the side end surface of the upper polarizing plate.

11. The liquid crystal display device according to claim 9, wherein the recess has an opening with a square shape on the first surface of the color filter substrate.

12. The liquid crystal display device according to claim 9, wherein the upper surface of the conductive adhesive is flush with the first surface.

13. The liquid crystal display device according to claim 9, wherein the conductive adhesive is a conductive silver paste.

14. The liquid crystal display device according to claim 9, wherein the conductive adhesive is filled in the recess by a coating process or a printing process.
